(19) United States
(12) Patent Application Publication
(10) Pub. No.: US 2009/0186532 A1
(43) Pub. Date: Jul. 23, 2009

(54) Communications jacks with selectively engageable contact support structures

(75) Inventors: Robert Ray Goodrich, Indianapolis, IN (US); Brian Fitzpatrick, McKinney, TX (US)

Correspondence Address: MYERS BIGEL SIBLEY & SAJOVEC, P.O. BOX 37428, RALEIGH, NC, 27612, US

(73) Assignee: CommScope, Inc.

(21) Appl. No.: 12/016,338

(22) Filed: Jan. 18, 2008

(51) Int. Cl. H01R 24/00

(52) U.S. Cl. 439/676

(57) ABSTRACT

Communications jacks include a housing having a plug aperture, a wiring board that is mounted at least partially within the housing, a set of contacts mounted on the wiring board and extending into the plug aperture, and a contact support that is mounted at least partially within the plug aperture. The contact support is configured to be moveable between a first position and a second position. The contact support may be configured to engage at least some of the contacts when a first type of communications plug is received within the plug aperture, and may be configured to not provide support to any of the contacts when a second type of communications plug is received within the plug aperture.

### FIELD OF THE INVENTION

The present invention relates generally to communications connectors and, more particularly, to communications jacks that include contacts that engage the blades of a mating communications plug.

### BACKGROUND

Many hardwired communications systems use plug-jack connectors to connect a communications cable to another communications cable or to a piece of equipment such as a computer, printer, server or patch panel. By way of example, high speed communications systems routinely use such plug-jack connectors to connect computers, printers and other devices to local area networks and/or to external networks such as the Internet. FIG. 1 depicts an example of such a hardwired high speed communications system that illustrates how plug-jack connectors may be used to interconnect a computer 1 to, for example, a network server 10.

As shown in FIG. 17 the computer 1 is connected by a cable 2 to a communications jack 5 that is mounted in a wall plate 9. The cable 2 is a patch cord that includes a communications plug 3, 4 at each end thereof. Typically, the cable 2 includes a plurality of wire conductors (e.g., eight), which are arranged in pairs so that each pair of conductors may carry a separate differential signal. Communications plug 3 inserts into a communications jack (not pictured in FIG. 1) provided in the back of the computer 1. Communications plug 4 inserts into an opening 6 in the front side of the communications jack 5 so that the contacts of the communications plug 4, which are typically referred to as blades, mate with respective contacts of the communications jack 5 (if the cable 2 includes eight conductors, the communications plugs 3, 4 and the communications jack 5 will typically each have eight contacts). The communications jack 5 includes a connector assembly 7 at the back end thereof that receives and holds a plurality of conductors (e.g., eight) from a second cable 8 that are individually pressed into slots in the connector assembly 7 to establish mechanical and electrical connections between each conductor of the second cable 8 and a respective one of a plurality of conductive paths through the communications jack 5. The other end of the second cable 8 is connected to a network server 10 which may be located, for example, in a telecommunications closet of a commercial office building. Thus, the patch cord 2, the cable 8 and the communications jack 5 provide a plurality of electrical paths (e.g., four differential signal paths) between the computer 1 and the network server 10. Each of these electrical paths may be used to communicate electrical information signals between the computer 1 and the network server 10. It will be appreciated that typically one or more patch panels or switches, along with additional communications cabling, would be included in the electrical path between the second communications cable 8 and the network server 10. However, for ease of description, these additional elements have been omitted from FIG. 1 and the second communications cable 8 is instead shown as being directly connected to the network server 10.

In order to provide standardization between the high speed communications equipment marketed and sold by different vendors, various industry standards documents have been promulgated that specify various mechanical and electrical properties for communications jacks and plugs. One example of such a standard is the TIA/EIA-568-B.2-1 standard approved Jun. 20, 2002 by the Telecommunications Industry Association. These industry standard documents typically incorporate by reference interface and wiring standards that specify, among other things, the dimensions and configurations of various types of standardized communications plugs and jacks so that industry standards-compliant plugs and jacks sold by different vendors will work with each other.

By way of example, the above-referenced TIA/EIA-568-B.2-1 standard requires compliance with interface specifications set forth in the FCC Part 68.500 document, which defines, among other things, the dimensions and configurations for various plug-jack interfaces, including plugs and jacks that conform to the Registered Jack 45 (“RJ-45”) wiring standard and plugs and jacks that conform to the Registered Jack 11 (“RJ-11”) wiring standard. The RJ-45 wiring standard describes wiring specifications for eight wire connector assemblies (including plugs and jacks) that are commonly used, for example, in Ethernet networks to connect computers and other hardware to local area networks (LAN) and/or the Internet. The RJ-11 wiring standard, on the other hand, describes wiring specifications for four and six wire connector assemblies that are used in the United States primarily to connect telephone equipment.

FIG. 2 is an exploded view of a conventional RJ-45 communications jack 20 and a mating RJ-45 communications plug 50. As shown in FIG. 2, this particular RJ-45 jack 20 has a three piece housing 21-23. Housing piece 21 defines a plug aperture 24. Housing piece 22 protects and supports a wiring board 25. Eight jackwire contacts 31-38 are mounted on the wiring board 25 so as to extend into the plug aperture 24. A plurality of wire connection terminals 41-48 (which are implemented as insulation displacement contacts or “IDCs” in the jack of FIG. 2) are also mounted on the wiring board 25. Each of the IDCs 41-48 is connected to a respective one of the jackwire contacts 31-38 via conductive traces/paths on the wiring board 25 (these conductive traces are not visible in FIG. 2). Housing piece 23 may cover and protect the IDCs 41-48. Housing piece 23 includes eight open-ended slots 26 that are configured to receive the individual conductors of a communications cable so as to allow the individual conductors to be inserted into the slots of respective of the IDCs 41-48. Housing piece 23 further includes one or more mounting posts that project from a bottom surface thereof and which are aligned with one or more mounting holes (not visible in FIG. 2) provided in the wiring board 25. When the communications jack 20 is assembled, the mounting posts pass through the holes in the wiring board 25 so that they may be ultrasonically welded to housing piece 22. Thus, when the jack 20 is assembled, the wiring board 25 is captured between housing pieces 22 and 23. Once the housing pieces 22 and 23 have been joined with the wiring board 25 therebetween, the forward edge of wiring board 25 is inserted into the rear opening in the housing piece 21 until snap clips on housing piece 23 snap into place in their respective recesses 24 in housing piece 21 to fully assemble the jack 20.

As is also shown in FIG. 2, the plug aperture 24 of communications jack 20 is configured to receive the front portion of the housing 52 of RJ-45 communications plug 50. The communications plug 50 includes eight plug contacts 61-68 (not visible in FIG. 2) which are received within slots 71-78 on the front and/or bottom surface of the housing 52 of communications plug 50. The slots 71-78 on communications plug 50 are positioned so that when communications plug 50 is inserted into communications jack 20, the slots 71-78 are aligned with plug contact regions of respective ones of jackwire contacts 31-38. Thus, when the communications plug 50 is inserted into the plug aperture 24 of communications jack 20, the plug blades 61-68 make mechanical and electrical connection with respective ones of the jackwire contacts 31-38. Typically, the contacts 31-38 of jack 20 are cantilevered jackwire contacts that are formed of a resilient material. The plug-jack interface is typically designed so that, as the plug 50 is inserted into plug aperture 24, the blades 61-68 of the plug 50 engage their respective contacts 31-38 and deflect them back and/or downward a short distance. The resiliency of the jackwire contacts 31-38 creates a “contact force” that holds the jackwire contacts 31-38 in firm engagement with their respective plug blades 61-68. When the plug 50 is removed, the jackwire contacts 31-38 move upwardly and/or forwardly back into their normal resting position.

FIG. 3A is a simplified perspective view of RJ-45 communications jack 20, and FIG. 3B is a simplified plan view of RJ-45 communications plug 50. FIG. 4A is a simplified perspective view of an RJ-11 communications jack 80, and FIG. 4B is a simplified plan view of an RJ-11 communications plug 90. As is evident from FIGS. 3A-4B, RJ-45 connector assemblies look very similar to RJ-11 connector assemblies, except that RJ-45 plugs and jacks are slightly wider than RJ-11 plugs and jacks and include two more contacts. Moreover, telephone and facsimile lines that are wired using RJ-11-style plugs and jacks are often located in the telecommunications closet of a building in close proximity to Ethernet equipment that is wired using RJ-45 plugs and jacks. Due to the visual similarities between the RJ-11 and RJ-45 connector assemblies, and their close proximity in many telecommunications closets, all too often, the slightly narrower RJ-11 plugs are accidentally inserted into RJ-45 jacks.

Unfortunately, when an RJ-11 plug is inserted into an RJ-45 jack, the RJ-45 jack can be damaged. This can best be seen with reference to FIG. 5, which is a cross sectional diagram taken along line 5-5 of FIG. 2. As shown in FIG. 5, the height of the housing 52 of plug 50 is about 0.260″. However, the plug blades 61-68 that are mounted in the slots 71-78 do not extend all the way to the bottom of housing 52. Accordingly, the effective height of the housing 52 along respective ones of the slots 71-78 is somewhat less (approximately 0.023″ less) than the height of the housing 52. The same is true with respect to plug 90 of FIG. 4B, namely the height of the housing 99 of plug 90 is approximately 0.260′, while the distance from the bottom edge of each plug blade 92-97 to the top of the housing 99 is only about 0.237″.

When RJ-11 plug 90 is inserted into RJ-45 jack 20, the housing 99 of the plug 90 engages contacts 31 and 38 of jack 20, as the six blade RJ-11 plug 90 does not include slots or blades in the outside two positions (i.e., the major difference between RJ-11 plug 90 and an RJ-45 plug 50 is that the RJ-11 plug 90 does not include slots 71 and 78 and contacts 61 and 68 that are included on the RJ-45 plug 50). As the housing 99 of RJ-11 plug 90 (as opposed to contacts of plug 90), which has the full height of 0.260″, engages jack contacts 31 and 38, the outside contacts 31 and 38 of jack 20 are over-deflected by 0.023″ when RJ-11 plug 90 is accidentally inserted into RJ-45 Jack 20 (as compared to when an RJ-45 plug is inserted). Unless the contacts 31 and 38 of jack 20 are specially designed to accommodate this additional amount of deflection, the contacts 31 and 38 may become permanently set in this over-deflected position if RJ-11 plug 90 is inserted into RJ-45 jack 20 (i.e., the contacts lose some or all of their ability to spring back into their resting position). If this occurs, when an RJ-45 plug 50 is later inserted into the RJ-45 jack 20, the “contact force” needed to keep blades 61 and 68 of the RJ-45 plug 50 in abutment with the respective jackwire contacts 31 and 38 of the RJ-45 jack 20 may not be present (or may be insufficient), which may result in poor performance. When insufficient contact force is present, the RJ-45 jack 20 may also fail to pass certain tests in the industry standards such as, for example, a specified minimum contact resistance that must be maintained between each plug blade and its respective jackwire contact after a minimum number of plug insertions and removals and under various environmental conditions (e.g., temperatures, relative humidity, etc.).

### SUMMARY

Pursuant to embodiments of the present invention, communications jacks are provided with features that facilitate, for example, usability of RJ-45 jacks with RJ-45 plugs after RJ-11 plugs have been used in the RJ-45 jacks.

Pursuant to certain embodiments of the present invention, communications jacks are provided which include a housing having a plug aperture and a plurality of contacts that extend into the plug aperture. These jacks further include a contact support that is mounted at least partially within the plug aperture. This contact support assumes a first position in which it engages and provides support to at least some of the contacts when a first type of communications plug is received within the plug aperture, and assumes a second position in which the contact support provides no support or lesser support to any of the contacts when a second type of communications plug is received within the plug aperture. The body of the first type of communications plug may be wider than the body of the second type of communications plug as would be the case, for example, if the first type of communications plug were an RJ-45 style communications plug and the second type of communications plug was an RJ-11 style communications plug.

In some embodiments of these jacks, the contact support may be a pivotally mounted contact support member that has a first end and a second end. The first end of the contact support member may have a first surface that engages a body of the first type of communications plug when one of the first type of communications plugs is inserted into the plug aperture. The second end of the contact support member may have at least one surface that pivots to engage at least one of the contacts when one of the first type of communications plugs is inserted into the plug aperture.

In some embodiments, the first end of the contact support member may include first and second protrusions that define a gap therebetween. This gap may be wider than a front surface of the body of an RJ-11 style communications plug but narrower than a front surface of the body of an RJ-45 style communications plug. The second end of the contact support member may be configured to engage and provide support to one of the contacts when the first type of communications plug is received within the plug aperture. Moreover, one of the contact may be configured to engage the second end of the contact support member and move the contact support member into the second position when the second type of communications plug is received within the plug aperture. In some embodiments, the jack may include a total of eight contacts. The plug contact regions of, for example, the first and eighth contacts may sandwich the plug contact regions of the second through seventh contacts. In these embodiments, the contact support may engage only the first and eighth contacts when the first type of communications plug is received within the plug aperture.

Pursuant to further embodiments of the present invention, communications jacks are provided which include a housing having a plug aperture, a plurality of contacts that are mounted so that a plug contact region of each of the plurality of contacts extends into the plug aperture, and a support member that is pivotally mounted at least partially within the plug aperture. The support member is configured to pivot between a first position and a second position. In some embodiments, the support member includes a first end and a second end, and is mounted so that a portion of the second end engages and provides support to at least some of the contacts when the support member is in the first position. The first end of the support member may include a recessed area that is wider than the front surface of the body of an RJ-11 style plug but narrower than the front surface of the body of an RJ-45 style plug. As a result, when an RJ-45 style communications plug is inserted into the plug aperture the RJ-45 style communications plug engages the first end of the support member to pivot the support member into the first position. However, when an RJ-11 style communications plug is inserted into the plug aperture, the RJ-11 style communications is received within the recessed area and the support member remains in the second position.

Pursuant to still further embodiments of the present invention, methods of selectively providing support to at least some of the jackwire contacts on a communications jack are provided. Pursuant to these methods, a first type of communications plug (e.g., an RJ-45 style communications plug) is inserted into a plug aperture of the jack so that a body of the first type of communications plug directly engages and moves a contact support member of the jack into a first position in which the contact support member engages and supports at least some of the contacts. In these methods, the body of the first type of communications plug, may cause the contact support member to rotate about a pivot point to move the contact support member from a second position into the first position. Moreover, these methods may also involve (1) removing the first type of communications plug and then (2) inserting a second type of communications plug (e.g., an RJ-11 style communications plug) into the plug aperture so that a body of the second type of communications plug engages and moves at least one of the jackwire contacts. The movement of this contact moves the contact support member of the jack into the second position. In addition, the methods may also involve (3) removing the first type of communications plug so as to allow the contact support member to move into the second position and then (4) inserting a second type of communications plug into the plug aperture of the communications jack, where the contact support member remains in the second position after the second type of communications plug is received within the plug aperture.

### BRIEF DESCRIPTION OF THE DRAWINGS

FIG. 1 illustrates the use of communications plug and communications jack connectors to interconnect a computer with network equipment.

FIG. 2 is an exploded perspective view of an RJ-45 communications jack and a perspective view of an RJ-45 communications plug that may be inserted into the RJ-45 communications jack.

FIG. 3A is a simplified perspective view of an RJ-45 communications jack.

FIG. 3B is a simplified plan view of an RJ-45 communications plug.

FIG. 4A is a simplified perspective view of an RJ-11 communications jack.

FIG. 4B is a simplified plan view of an RJ-11 communications plug.

FIG. 5 is a cross-sectional view of the communications plug of FIG. 2 taken along the line 5-5 thereof.

FIG. 6 is a cross-sectional view of a communications jack according to first embodiments of the present invention.

FIG. 7 is a cross-sectional view of a communications jack according to further embodiments of the present invention.

FIG. 8A is a plan view of the contact support and several other components of the jack of FIG. 7.

FIG. 8B is a front view of the contact support of the jack of FIG. 7 taken along the line 8-8 thereof, with the contact support member in the dotted line position of FIG. 7.

FIG. 9 is a perspective view of a communications jack according to still further embodiments of the present invention.

FIGS. 10A and 10B are cross-sectional views of the jack of FIG. 9.

FIG. 11 is a flow chart illustrating operations of methods of selectively providing support to jackwire contacts according to certain embodiments of the present invention.

### DETAILED DESCRIPTION

The present invention will be described more particularly hereinafter with reference to the accompanying drawings. The invention is not intended to be limited to the illustrated embodiments; rather, these embodiments are intended to hilly and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

This invention is directed to communications connectors, with a primary example of such being a communications jack (e.g., a modular jack, a patch panel jack, etc.). As used herein, the terms “forward”, “forwardly”, and “front” and derivatives thereof refer to the direction defined by a vector extending from the center of the jack toward the plug opening of the jack. Conversely, the terms “rearward”, “rearwardly”, and derivatives thereof refer to the direction directly opposite the forward direction; the rearward direction is defined by a vector that extends away from the plug opening toward the remainder of the jack. Where used, the terms “attached”, “connected”, “interconnected”, “contacting”, “mounted” and the like can mean either direct or indirect attachment or contact between elements, unless stated otherwise.

FIG. 6 is a cross sectional view of a communications jack 100 according to certain embodiments of the present invention. It will be appreciated that some conventional elements of the communications jack 100 such as, for example, IDCs, are not depicted in FIG. 6. As shown in FIG. 6, the communications jack includes a housing 102 that defines a plug aperture 108. The housing may be any conventional or unconventional housing structure, and may comprise a one-piece or a multi-piece housing. A wiring board 104 is mounted at least partially within the housing 102. A plurality of contacts 106 (only one contact is visible in FIG. 6) may be mounted on the wiring board 104 so as to extend into the plug aperture 108. In FIG. 6, the contacts are mounted adjacent the front of wiring board 104 and are cantilevered to extend toward the rear of the jack 100. In other embodiments, the contacts 106 may be cantilevered to extend from the rear of the jack 100 toward the front of the jack 100. It will be appreciated that, in either case, the contacts 106 “extend into” the plug aperture 108, as the mounted end of each contact 106 is outside the plug aperture 108 and at least part of each contact 106 extends into the plug aperture 108 to be in position to engage the blade of a mating plug. While the contacts 106 of the embodiment depicted in FIG. 6 all have the same profile and are aligned in a side-by-side relationship, it will be appreciated that in other embodiments the contacts 106 may have different profiles, may not be aligned (except to the extent that general alignment is required in the plug contact region of the contacts to conform to industry standards), may include crossovers, may have staggers where they enter the circuit board, etc.

As is further shown in FIG. 6, the communications jack 100 also includes a contact support 110 that is mounted at least partially within the plug aperture 108. The contact support 11 is configured to assume a first position 112 when a first type of communications plug (not shown in FIG. 6) is received within the plug aperture 108, and to assume a second position 114 when a second type of communications plug (not shown in FIG. 6) is received within the plug aperture 108. The contact support 110 does not provide support to any of the plurality of contacts 106 when the second type of communications plug is received within the plug aperture 108. In contrast, when the first type of communications plug is received within the plug aperture 108, the contact support 110 moves into the second position 114 where it engages, and provides support to, at least some of the plurality of contacts 106. Herein, a contact support is considered to “provide support” to a contact if it applies a force on the contact that helps hold the contact against the blade of a mating plug that is received within a plug aperture of a jack. In some embodiments, the first type of communications plug may be an RJ-45 style communications plug and the second type of communications plug may be an RJ-11 style communications plug.

While not shown in FIG. 6, in some embodiments, the contact support 110 may be a pivotally mounted contact support member that has a first end and a second end. This contact support member may pivot between the first and second positions depending upon, for example, the type of communications plug received within the plug aperture 108. It will be appreciated, however, that in other embodiments non-pivoting contact support members may be used that move between first and second positions. By way of example, one or more sliding members and/or sliding members that cooperate with other members could be used instead of such a pivoting member.

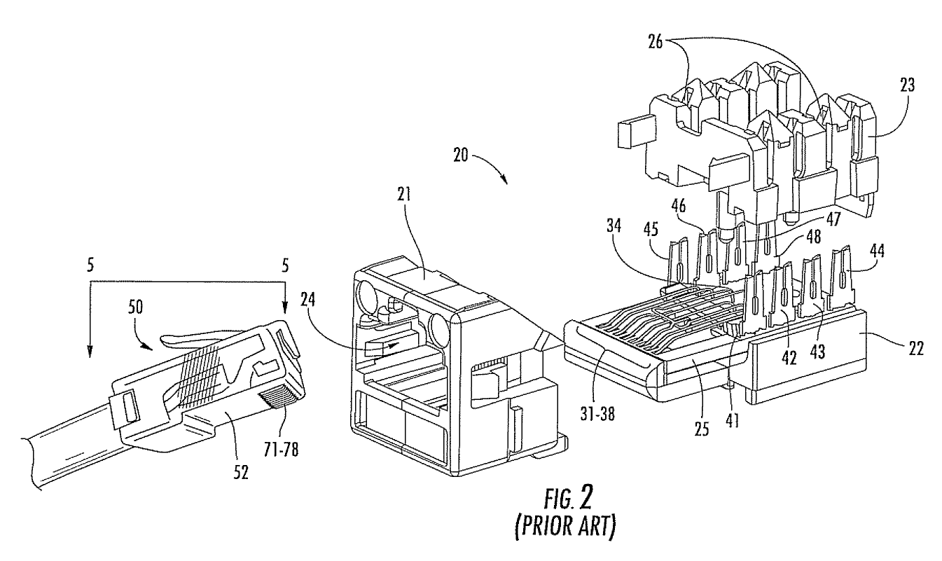

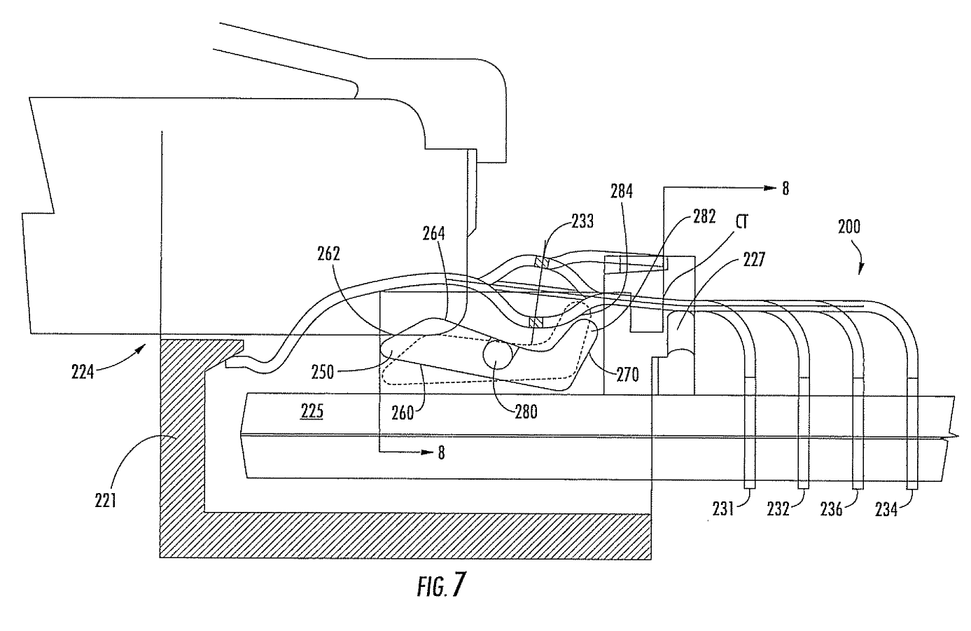

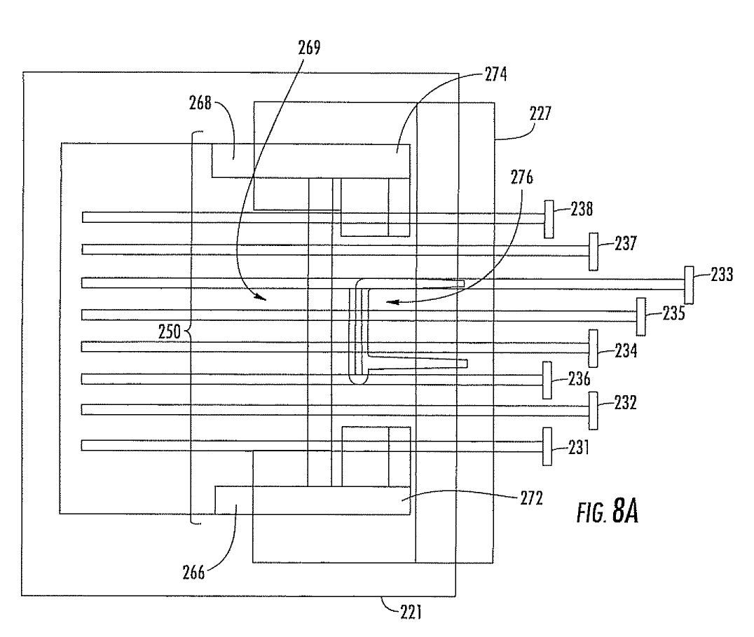

FIG. 7 is a cross-sectional view of portions of an RJ-45 communications jack 200 according to further embodiments of the present invention. The communications jack 200 may be similar to the communications jack 20 illustrated in FIG. 2, except that the jack 200 further includes a contact support 250. In order to simplify FIG. 7, the housing pieces that correspond to housing pieces 22 and 23 of FIG. 2 have been omitted, as have the wire connection terminals that correspond to IDCs 41-48 of FIG. 2. It will be appreciated that these or other conventional housing pieces and wire connection terminals may be provided on the communications jack 200.

As shown in FIG. 7, the communications jack 200 includes a housing 221 that defines a plug aperture 224 (in order to simplify FIG. 7, only part of housing 221 is depicted). Housing 221 receives a front part of a wiring board 225 which is inserted into an opening in the rear of the housing 221. The wiring board 225 may comprise, for example, a single or multi-layered printed circuit board that includes a plurality of conductive traces or paths (not visible in FIG. 7) that extend between, and electrically connect, input terminals of the printed circuit board 225 to respective output terminals of the printed circuit board 225 (the input and output terminals are discussed in more detail below). It will be understood that the wiring board 225 may alternatively comprise a flexible printed circuit board or some other type of substrate that includes conductive paths that connect input terminals to respective output terminals. The wiring board 225 may also include electrical circuit components or devices arranged on or within the board to compensate for crosstalk that may otherwise be present in the jack 200 and/or in an associated plug that mates with the jack 200. Such devices include, but are not limited to, closely spaced wire traces printed on or within layers of the wiring board 225 (including, for example, side-by-side conductive trace segments and overlying conductive trace segments), plate capacitors implemented on two or more layers or surfaces of the board, interdigitated finger capacitors such as the interdigitated finger capacitors disclosed, for example, in U.S. Pat. No. 5,997,358, and discrete electrical components such as inductors, capacitors or resistors that are mounted on or within the wiring board 225.

The jack 200 further includes a plurality of jackwire contacts 231-238 that are mounted on the printed circuit board 225 (only contacts 231-234 and 236 are visible in the cross-sectional view of FIG. 7). Herein, the term “contact”, when used as a noun, refers to an electrically conductive element that is designed to establish physical and electrical contact with an electrically conductive element on another device. The jackwire contacts 231-238 depicted in FIG. 7 are one such type of contact that is known in the art. The contacts 231-238 are referred to as “jackwire” contacts because the contacts are configured to resiliently deflect from a resting position when contacted by a mating plug, and then recover or “spring back” to the resting position when the mating plug is removed. Each contact 231-238 includes a plug contact region that is configured to make mechanical and/or electrical contact with a blade of a communications plug that is inserted into the communications jack 200. Each jackwire contact 231-238 may be formed, for example, of a copper alloy such as spring-tempered phosphor bronze, beryllium copper, or the like. A typical cross-section of each jackwire contact 231-238 is 0.015 inch wide by 0.010 inch thick, although other sized and/or shaped (e.g., round) contacts may be used. As will be discussed in more detail herein, in the embodiment depicted in FIG. 7, the jackwire contacts 231-238 deflect downwardly when a mating plug is received within the plug aperture 224. It will also be appreciated that typically the jack 200 will be installed in an orientation that is inverted from the orientation shown in FIG. 7 in order to reduce buildup of dust and dirt on the contacts of the jack 200 (and hence the jackwire contacts 231-238 will deflect upwardly when the jack 200 is installed in such an orientation).

The contacts 231-238 in the jack 200 of FIG. 7 may be identical to the +contacts 31-38 depicted in the jack of FIG. 2. As shown in FIG. 2, contacts 31-32, 34-35 and 37-38 (and hence contacts 231-232, 234-235 and 237-238 of jack 200 as well since they have the same configuration) are generally planar contacts that lie exclusively within a single plane. In contrast, contacts 33 and 36 (and hence contacts 233 and 236 of jack 200 as well) include a crossover. The configuration of contacts 231-238 may be implemented, for example, in a manner similar or identical to one of the contact configurations disclosed in U.S. Pat. No. 7,204,722 or in U.S. patent application Ser. No. 11/688,458, filed Mar. 20, 2007, the entire contents of both of which are hereby incorporated herein by reference. Accordingly, further explanation as to how this crossover may be implemented will be omitted. It will be appreciated, however, that the contacts 231-238 may include no crossovers or different crossovers such as, for example, the crossover configuration depicted in U.S. Pat. No. 6,186,834 in further embodiments of the present invention.

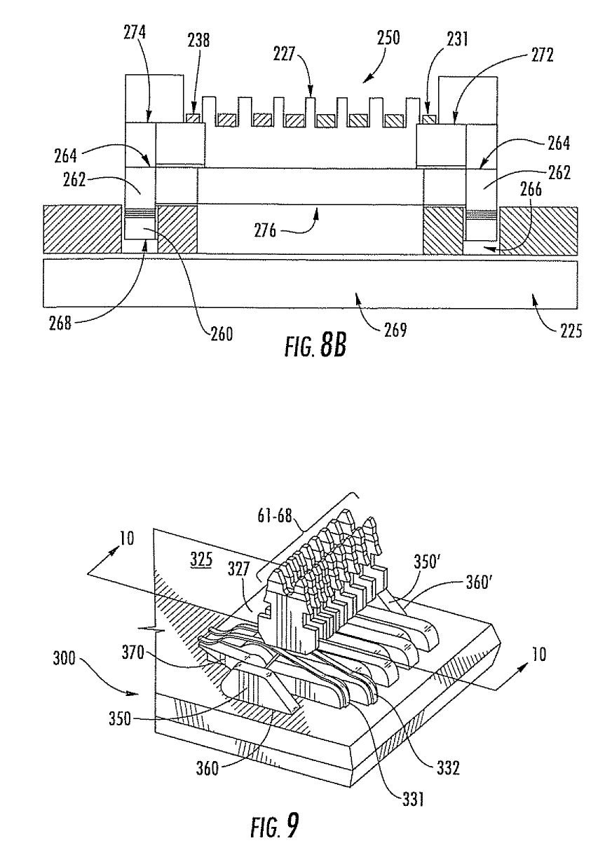

As is also shown in FIG. 7, the jack 200 may include a fixed contact support structure. In the embodiment of FIG. 7, this fixed contact support structure comprises a guide structure 227 that is mounted, for example, on the wiring board 225. The guide structure 227 may, for example, provide support to the lower surface of the contacts 231-238. The guide structure 227 may also include a plurality of recesses that define a comb structure that facilitates keeping the contacts 231-238 in proper alignment by positioning each of the contacts 231-238 in respective one of the recesses as shown in FIG. 8B.

As noted above, each conductive path on the printed circuit board 225 connects an input terminal of the printed circuit board 225 to an output terminal of the printed circuit board. In the communications jack 200, the input terminals of the printed circuit board 225 comprise the metal-plated holes that receive the fixed end of the respective contacts 231-238 (only four of the holes are visible in the cross-sectional diagram of FIG. 7). The output terminals of the printed circuit board may also comprise a plurality of metal-plated holes (not shown in FIG. 7) that receive wire connection terminals such as the IDCs 41-48 depicted in FIG. 2.

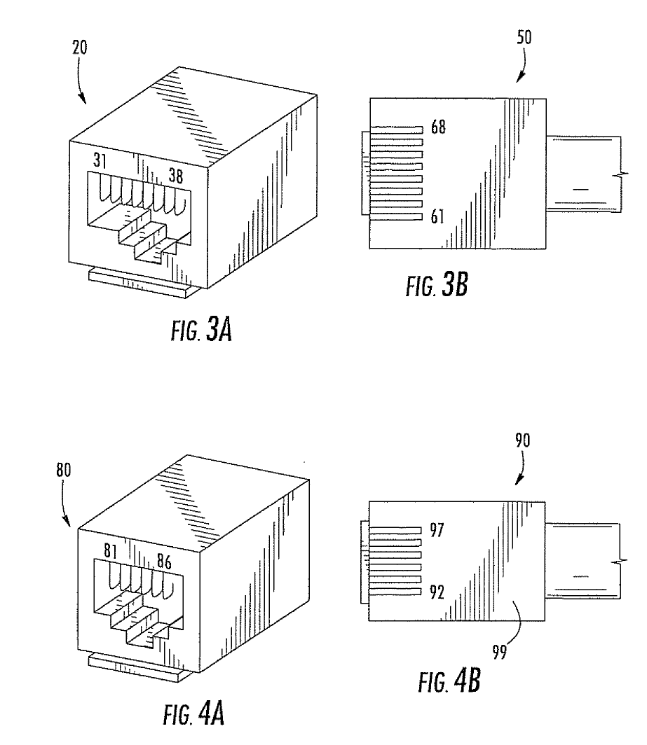

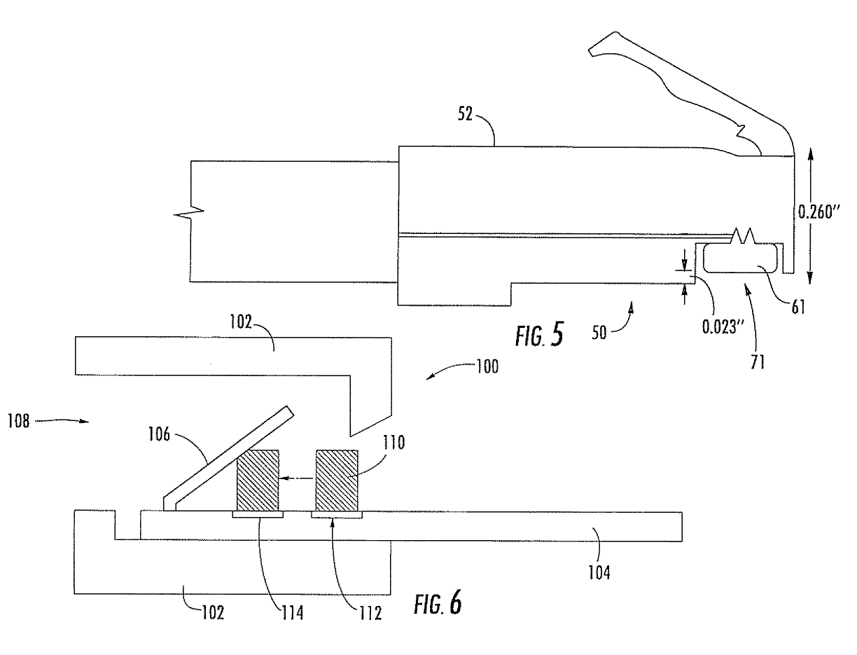

As discussed above, when an RJ-11 plug such as RJ-11 plug 90 of FIG. 4B is inserted into the RJ-45 jack 200 of FIG. 7, the housing 99 of RJ-11 plug 90 engages contacts 231 and 238 of jack 200, while the blades 92-97 of plug 90 engage jackwire contacts 232-237, respectively. As the housing 90 nominally extends 0.023″ lower than the contacts 92-97, jackwire contacts 231 and 238 are deflected beyond their normal deflected positions (i.e., beyond their deflected positions when the RJ-45 plug 50 of FIG. 3B is inserted into the RJ-45 jack 200). As indicated above, contacts 231 and 238 of RJ-45 jack 200 may become permanently deformed as a result of this abnormal deflection after the RJ-11 plug 90 has been removed.

In order to ensure that contacts 231 and 238 will exert sufficient contact force even after the accidental insertion of an RJ-11 plug into jack RJ-45 jack 200, the jack 200 includes a rotating contact support 250 within the fixed guide member 227. As shown in FIG. 7, in some embodiments, this rotating contact support 250 may be implemented as a contact support member 250 that pivots about a pivot pin 280. The contact support member 250 has a first end 260 and a second end 270. The first end 260 includes a first edge 262 and a second edge 264. As shown in FIGS. 7 and 8B, the contact support member 250 may pivot between a first position 282 and a second position 284 (the second position 284 is shown by drawing the contact support member 250 using a dotted line).

FIG. 8A is a plan view of the contact support member 250 of FIG. 7, which also shows the housing 221, the contacts 231-238 and the guide structure 227. FIG. 8B is a front view of the contact support member 250 of FIG. 7 taken along the line 8-8 thereof, with the contact support member 250 in the dotted line position of FIG. 7. For clarity, the portion of the contacts 231-238 that protrude forward of point CT of FIG. 7 are not shown in FIG. 8B. As shown in FIGS. 8A and 8B, the first end 260 has two finger-like protrusions 266 and 268 that are separated by a gap 269. The gap 269 may be sized to have a width that is greater than the width of the housing of an RJ-11 plug so the gap 269 will receive the housing of an RJ-11 plug that is inserted within the plug aperture 224 of jack 200. The gap 269, however, is narrower than the width of the housing of an RJ-45 plug. Thus, when an RJ-45 is inserted into the plug aperture 224, the housing of the RJ-45 plug comes into contact with, and moves, the two finger-like protrusions 266 and 268. The second end 270 likewise includes two generally upwardly extending protrusions 272 and 274 that are separated by a recessed area 276. As shown in FIG. 8A, a portion of protrusion 272 is aligned underneath contact 231 and a portion of protrusion 274 is aligned underneath contact 238.

When an RJ-11 plug 90 is inserted into the plug aperture 224, the housing of the plug 90 is received in the gap 269 such that the plug 90 does not come into contact with contact support member 250 (or if it does come into contact, it does not exert sufficient force on contact support member 250 to pivot contact support member 250 into a different position). Consequently, the contact support member 250 remains in approximately the first position 282 (see FIG. 7). As shown in FIG. 7, in this first position 282, the contact support member 250 does not engage any of the contacts 231-238.

In contrast, when an RJ-45 plug 50 is inserted into plug aperture 224, the plug housing 52 engages the first edges 262 of the two finger-like protrusions 266 and 268 that are provided on the first end 260 of contact support member 250. The force exerted by the plug housing 52 on the first edges 262 of these protrusions 266, 268 causes the first end 260 of contact support member 250 to rotate downwardly about the pivot point 280 so that the plug housing 52 en-ages the second edges 264 of the finger-like protrusions 266 and 268. As the first end 260 of contact support member 250 rotates downwardly, the second end 270 rotates upwardly so that the protrusions 272 and 274 on the second end 270 engage the lower surface of contacts 231 and 238, respectively, thereby moving these contacts upward and providing support to these contacts so as to increase the amount of contact force between these contacts 231 and 238 and the respective blades of the RJ-45 plug 50 with which they mate. Thus, as is clear from the above description, when an RJ-45 plug 50 is inserted into the plug aperture 224, the contact support member 250 pivots from the first position 282 to the second position 284 so that the second end 270 of contact support member 250 engages, and provides support to, at least contacts 231 and 238.

It will be appreciated that numerous modifications may be made to the contact support member 250. By way of example, while the contact support member 250 depicted in FIGS. 7 and 8A-8B includes two protrusions 272 and 274 on the second end thereof that are separated by a gap 276, in other embodiments the second end 270 may comprise an upwardly extending member that has no gap and/or that engages all eight contacts 231-238. Likewise, while the contact support member 250 is implemented as a one piece contact support member, two separate contact support members could be provided instead; one that selectively provides support to contact 231 and another that selectively provided support to contact 238. In other embodiments the contact support member 250 may be spring-loaded to bias it toward a preferred position.

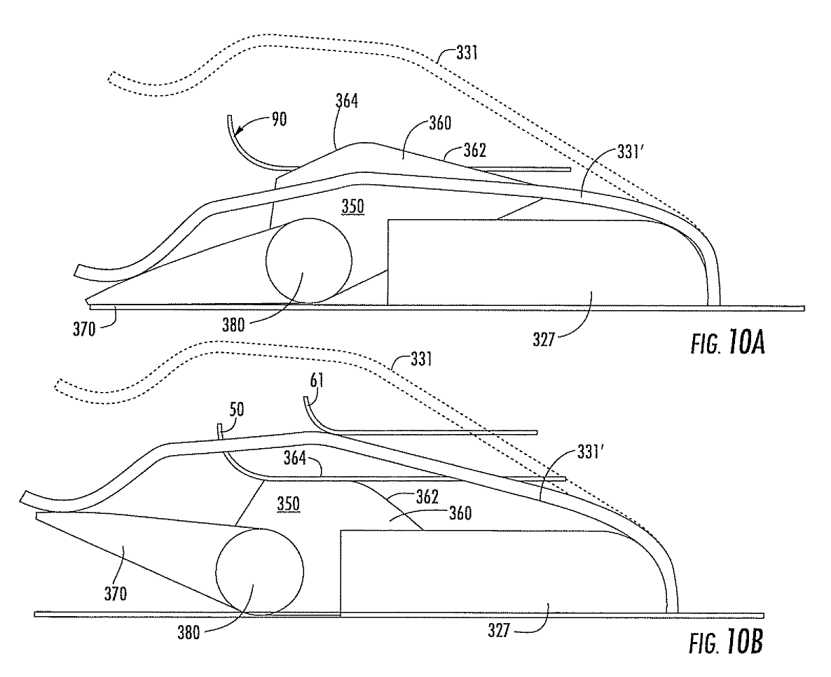

FIG. 9 is a perspective view of portions of an RJ-45 communications jack 300 according to further embodiments of the present invention. Various conventional elements of the communications jack 300 such as, for example, the jack housing and IDCs, are not depicted in FIG. 9. It will be appreciated that any conventional housings, wire connection terminals, etc. may also be included with jack 300 to provide a complete jack. As shown in FIG. 9, the communications jack 300 includes a wiring board 325, contacts 331 and 332 (the jack 300 would also include contacts 333-338, but these contacts are omitted to simplify FIG. 9). The jack 300 also includes a fixed contact support/guide structure 327 and a pair of contact support members 350, 350′. The contact support members 350, 350′ may be, the same part or separate parts. FIG. 9 also depicts the location of the blades 61-68 of mating RJ-45 plug 50 when such a plug 50 is received within the plug aperture of communications jack 300. Operation of the contact support member 350 is described below with reference to FIGS. 10A-10B.

FIGS. 10A and 10B are cross-sectional views of the communications jack 300 taken along the line 10-10 of FIG. 9. In particular, FIG. 10A is a cross-sectional view that shows the positioning of contact 331 and contact support member 350 of jack 300 when an RJ-11 plug is received within the plug aperture of jack 300. FIG. 10B, on the other hand, is a cross-sectional view that shows the positioning of contact 331 and contact support member 350 of jack 300 when an RJ-45 plug is received within the plug aperture of jack 300. For ease of description, additional parts of jack 300 are not depicted in FIGS. 10A and 10B including, for example, the printed circuit board 325 and jackwire contact 332.

As shown in FIG. 10A, in the communications jack 300, at least some of the contacts, including depicted contact 331, are cantilevered from the front toward the rear of the jack. In FIGS. 10A and 10B, reference numeral 331 indicates the positioning of the contact 331 before a plug is inserted into the plug aperture of jack 300, while reference numeral 331′ shows the positioning of the contact 331 after a plug has been received within the plug aperture of jack 300. Contact 331 (and each of the non-pictured contacts) includes a plug contact region that is configured to make mechanical and/or electrical contact with a blade of a communications plug that is inserted into the communications jack 300. Contact 331 may be formed, for example, of a copper alloy such as spring-tempered phosphor bronze, beryllium copper, or the like. Contact 331 may also have a smaller cross-section than conventional contacts. For example, contact 331 (and the non-pictured contacts) may be about 0.015 inches wide by about 0.006 inches thick. Other contact lengths, shapes and sizes may also be used. As with jack 200 above, it will be appreciated that jack 300 typically will be installed in an orientation that is inverted from the orientation shown in FIGS. 9, 10A and 10B. As is also shown in FIGS. 10A and 10B, the fixed contact support/guide structure 327 provides support to the lower surface of the contacts. The fixed contact support/guide structure 327 may also include a plurality of recesses (not depicted in FIGS. 9 and 10A-10B) that define a comb structure that facilitates keeping the contacts in proper alignment by positioning each of the contacts in a respective one of the recesses.

As is also shown in FIGS. 10A and 10B, the jack 300 includes a moveable contact support 350. This moveable contact support 350 may be implemented as a contact support member 350 that pivots about a pivot pin 380. The contact support member 350 has a first end 360 and a second end 370. The first end 360 includes a first edge 362 and a second edge 364. As shown in FIGS. 10A and 10B, the contact support member 350 may pivot between a first position which is shown in FIG. 10A and a second position which is shown in FIG. 10B.

As shown best in FIG. 9, the first end 360 of contact support member 350 and the first end 360′ of contact support member 350′ define a gap therebetween. This gap may be sized to have a width that is greater than the width of the housing of an RJ-11 plug so the gap will receive the housing of an RJ-11 plug that is inserted within the plug aperture of jack 300. The gap, however, is narrower than the width of the housing of an RJ-45 plug. Thus, when an RJ-45 is inserted into the plug aperture, the housing of the RJ-45 plug comes into contact with, and moves, the respective first ends 360, 360′ of contact support members 350, 350′, as will be discussed in more detail below. The second ends 370, 370′ of contact support members 350, 350′ (second end 370′ of contact support member 350′ is not visible in the figures) are aligned underneath contacts 331 and 338, respectively (contact 338 is not depicted in the figures).

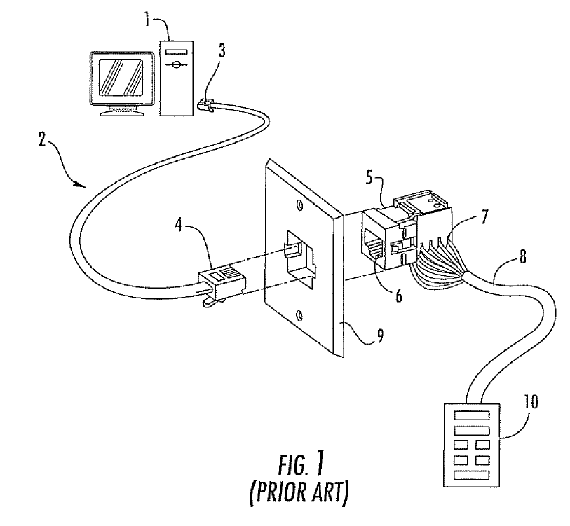

Referring again to FIG. 10A, when an RJ-11 plug 90 is inserted into the plug aperture (only an outline of a portion of the bottom of the housing of plug 90 is shown in FIGS. 10A and 10B), the housing of plug 90 is received in the gap between first ends 360, 360′ of contact support members 350, 350′ such that the plug 90 does not come into contact with contact support members 350, 350′ (or if it does come into contact, it does not exert sufficient force thereon to pivot either of the contact support members 350, 350′ into different positions). However, the housing of plug 90 does engage contact 331. As shown in FIG. 10A, due to this engagement, contact 331 moves from the position labeled with reference numeral 331 to the position labeled with reference numeral 331′. In moving between these positions, the free end of contact 331 engages an upper surface of second end 370 of contact support member 350, and forces contact support member 350 to pivot about pivot point 380. In this manner, contact support member 350 moves from a second position (namely the position of contact support member 350 shown in FIG. 10B) into the first position depicted in FIG. 1A. Thus, when an RJ-11 plug is inserted into the plug aperture of jack 300, the contact support member 350 moves in a manner that allows contact 331 to deflect more fully.

In contrast, as shown in FIG. 10B, when an RJ-45 plug 50 is inserted into the plug aperture, the plug housing engages the first edge 362 of the first end 360 of contact support member 350 (only an outline of a portion of the bottom of the housing of plug 50 and an outline of the bottom of a plug blade 61 are shown in FIG. 10B). The force exerted by the plug, housing on the first edge 362 causes the first end 360 of contact support member 350 to rotate downwardly about the pivot point 380 so that the plug housing engages the second edge 364 of first end 360. As the first end 360 of contact support member 350 rotates downwardly, the second end 370 rotates upwardly to en-age the lower surface of contact 331, thereby moving contact 331 upward and providing support to contact 331 so as to increase the amount of contact force between these contacts 331 and blade 61 of the mating RJ-45 plug 50. Contact support member 350′ operates in similar fashion to provide support to contact 338. Thus, as is clear from the above description, when an RJ-45 plug 50 is inserted into the plug aperture, the contact support members 350, 350′ pivot from their first positions (see FIG. 10A) to their second positions of FIG. 10B so that the second ends 370, 370′ of contact support members 350, 350′ engage, and provides support to, at least contacts 331 and 338.

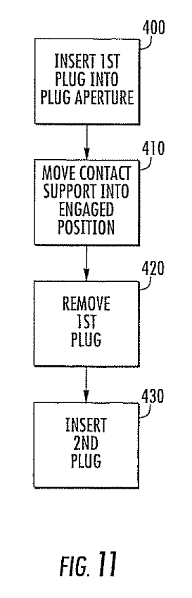

Pursuant to further embodiments of the present invention, methods of selectively providing support to at least some of a plurality of jackwire contacts on a communications jack are provided. FIG. 11 is a flow chart diagram that depicts operations according to various of these methods. As shown in FIG. 11, operations may begin with the insertion of a first type of communications plug (e.g., an RJ-45 communications plug) into, for example, a communications jack according to embodiments of the present invention (block 400). In response to the insertion of the first type of communications plug, a contact support member in the communications jack is moved into an engaged position in which the contact support member directly physically contacts and supports at least some of the plurality of contacts (block 410). This may be accomplished, for example, by using the body of the first type of communications plug to rotate the contact support member about a pivot point to move the contact support member into the engaged position. Next, operations may continue by removing the first type of communications plug (block 420). In some embodiments, this may allow the contact support member to move into a disengaged position. Thereafter, a second type of communications plug that is different from the first type of communications plug (e.g., an RJ-11 plug) may be inserted into the plug aperture of the communications jack (block 430). In response to insertion of this second type of plug the contact support member either moves to, or remains in, a disengaged position.

Embodiments of the present invention have been described above with respect to several specific communications jacks. It will be appreciated, however, that the illustrated communications jacks are exemplary in nature and merely provide examples of the types of jack with which the present invention may be implemented. Thus, it will be understood that the present invention is not limited to use with any particular jack.

It should also be noted that the present invention is not limited to being implemented only in connection with an RJ-45 communication jack to prevent damage thereto when an RJ-11 communication plug is inserted into the jack. The present invention applies equally to other types of jacks that may be susceptible to damage caused by insertion of a plug with which the jack is not configured to mate.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A communications jack, comprising:
a housing having a plug aperture;
a plurality of contacts extending into the plug aperture; and
a contact support that is mounted at least partially within the plug aperture, the contact support configured to assume a first position in which the contact support engages and provides support to at least some of the plurality of contacts when a first type of communications plug is received within the plug aperture and to assume a second position in which the contact support provides no support or lesser support to any of the plurality of contacts when a second type of communications plug is received within the plug aperture.

2. The communications jack of claim 1, wherein the contact support comprises a pivotally mounted contact support member that has a first end and a second end.

3. The communications jack of claim 2, wherein the first end of the contact support member has a first surface that is configured to engage a body of the first type of communications plug when one of the first type of communications plugs is inserted into the plug aperture, and wherein the second end of the contact support member has at least one surface that pivots to engage at least one of the plurality of contacts when the one of the first type of communications plugs is inserted into the plug aperture.

4. The communications jack of claim 3, wherein the first surface on the first end is configured to engage a leading edge of the body of the one of the first type of communications plug when one of the first type of communications plugs is inserted into the plug aperture, and wherein the first end includes a second surface that is configured to engage a surface of the one of the first type of communications plug that includes slots which expose a plurality of plug blades when the one of the first type of communications plug is fully received within the plug aperture.

5. The communications jack of claim 2, wherein the first end of the contact support member includes first and second protrusions that define a gap therebetween, and wherein the gap is wider than a front surface of the body of an RJ-11 style communications plug but narrower than a front surface of the body of an RJ-45 style communications plug.

6. The communications jack of claim 2, wherein the second end of the contact support member is configured to engage and provide support to a first of the plurality of contacts when the first type of communications plug is received within the plug aperture, and wherein the first of the plurality of contacts is configured to engage the second end of the contact support member and move the contact support member into the second position when the second type of communications plug is received within the plug aperture.

7. The communications jack of claim 1, wherein the plurality of contacts comprises eight contacts, and wherein a first and a second of the plurality of contacts have respective plug contact regions that sandwich the plug contact regions of the remaining six of the plurality of contacts, and wherein the contact support engages only the first and second of the plurality of contacts when the first type of communications plug is received within the plug aperture.

8. The communications jack of claim 1, wherein a body of the first type of communications plug is wider than a body of the second type of communications plug.

9. The communications jack of claim 1, wherein the first type of communications plug comprises an RJ-45 style communications plug and the second type of communications plug comprises an RJ-11 style communications plug.

10. A communications jack, comprising:
a housing having a plug aperture;
a plurality of contacts that are mounted so that a plug contact region of each of the plurality of contacts extends into the plug aperture; and
a support member that is pivotally mounted at least partially within the plug aperture, wherein the support member is configured to pivot between a first position and a second position.

11. The communications jack of claim 10, wherein the support member includes a first end and a second end, and is mounted so that a portion of the second end engages and provides support to at least some of the plurality of contacts when the support member is in the first position.

12. The communications jack of claim 11, wherein the first end of the support member includes a recessed area that is wider than the front surface of the body of an RJ-11 style plug but narrower than the front surface of the body of an RJ-45 style plug.

13. The communications jack of claim 12, wherein the support member is configured so that when an RJ-45 style communications plug is inserted into the plug aperture the RJ-45 style communications plug engages the first end of the support member to pivot the support member into the first position.

14. The communications jack of claim 13, wherein the support member is configured so that when an RJ-11 style communications plug is inserted into the plug aperture the RJ-11 style communications is received within the recessed area and the support member remains in the second position.

15. The communications jack of claim 10, wherein the plurality of contacts comprises eight contacts, and wherein the plug contact regions of a first and a second of the plurality of contacts sandwich the plug contact regions of the remaining six of the plurality of contacts, and wherein the contact support is configured to pivot to the first position so as to engage at least the first and second of the plurality of contacts when a first type of communications plug, is inserted into the plug aperture.

16. The communications jack of claim 15, wherein the first and second of the plurality of contacts are configured to engage the contact support member and move the contact support member into the second position when the second type of communications plug is received within the plug aperture.

17. A method of selectively providing support to at least some of a plurality of jack-wire contacts on a communications jack, the method comprising
inserting a first type of communications plug into a plug aperture of the communications jack so that a body of the first type of communications plug directly engages and moves a contact support member of the communications jack into a first position in which the contact support member engages and supports at least some of the plurality of contacts.

18. The method of claim 17, wherein the body of the first type of communications plug causes the contact support member to rotate about a pivot point to move the contact support member from a second position into the first position.

19. The method of claim 18, the method further comprising:
removing the first type of communications plug; and then
inserting a second type of communications plug into the plug aperture of the communications jack so that a body of the second type of communications plug engages and moves at least one of the plurality of jackwire contacts, and wherein the movement of the at least one of the plurality of jackwire contacts moves the contact support member of the communications jack into the second position.

20. The method of claim 18, the method further comprising:
removing the first type of communications plug so as to allow the contact support member to move into the second position; and then
inserting a second type of communications plug into the plug aperture of the communications jack, wherein the contact support member remains in the second position after the second type of communications plug is received within the plug aperture.

21. The method of claim 19, wherein the first type of communications plug comprises an RJ-45 style communications plug and the second type of communications plug comprises an RJ-11 style communications plug.
